(19) United States
(12) Patent Application Publication
(10) Pub. No.: US 2014/0084636 A1
(43) Pub. Date: Mar. 27, 2014

(54) Plastic component of a roof opening system

(71) Applicants: Rudolf Wimmer, Germering (DE); Matthias Dichtl, Eurasburg (DE)

(72) Inventors: Rudolf Wimmer, Germering (DE); Matthias Dichtl, Eurasburg (DE)

(73) Assignee: WEBASTO AG, Stockdorf (DE)

(21) Appl. No.: 14/006,263

(22) PCT Filed: Mar. 15, 2012
(86) PCT No.: PCT/EP12/54508

§ 371 Date: Oct. 17, 2013

(30) Foreign Application Priority Data
Mar. 24, 2011 (DE) 102011014989.9

(51) Int. Cl. B62D 25/06; B62D 29/04

(52) U.S. Cl. CPC B62D 25/06; B62D 29/043
USPC 296/216.07; 264/45.1; 264/255

(57) ABSTRACT

A method for manufacturing a sliding-roof frame of a roof-opening system of a motor vehicle in a tool having at least one mold cavity. One embodiment comprises the steps of: inserting at least one semifinished part configured in the shape of a panel into the tool; deep-drawing the semifinished part in the tool for configuring at least one deep-drawn section of the sliding-roof frame, wherein the semifinished part is formed from a glass-fiber reinforced thermoplastic and the step of deep drawing is a thermoforming process; then, introducing a plastic material into the mold cavity of the tool for forming at least one formed section, which is injection-molded or foamed, and for bonding said formed section to the deep-drawn section; and demolding the sliding-roof frame from the tool.

The invention relates to a method for manufacturing a component of a roof-opening system and to the component itself.

A component of a roof-opening system is, for example, a sliding-roof frame which is attached from above and/or below to a vehicle body during assembly on the production line of a vehicle manufacturer. Such sliding-roof frames to date are usually made of steel and on account of the material used contribute towards the inherent stiffness of the vehicle structure. Sliding-roof frames made of steel have a high dead weight, which is not desirable in particular in the roof region of a motor vehicle. Also, a steel sliding-roof frame is not corrosion-resistant. Moreover, a steel sliding-roof frame distinguishes itself by high manufacturing costs, one reason for which lies in a long development period of the tools used in manufacturing. Moreover, on a steel sliding-roof frame, functionalities for the roof system, such as, for example, a mounting for a wind deflector, can at times only be integrated with great effort.

The invention is based on the object of providing a method according to which a component, which is light and optimized in terms of the integration of functionalities, of a roof-opening system of a motor vehicle is manufacturable.

This object is achieved according to the invention by the method having the features of patent claim 1.

Thus according to the invention a method is proposed for manufacturing a component of a roof-opening system of a motor vehicle in a tool which comprises at least one mold cavity. In the method, at least one semifinished part configured in the shape of a panel is inserted into the tool. This semifinished part is deep-drawn in the tool for configuring at least one deep-drawn section of the component. By introducing a plastic material into the mold cavity of the tool, at least one formed section is formed and bonded to the deep-drawn section. The then finished component can subsequently be demolded from the tool and, if appropriate, be subjected to postprocessing.

In the method according to the invention, the deep-drawn section and the formed section of the component are thus produced in one tool, without any repositioning of the deep-drawn section taking place. The deep-drawing step and the injection molding or foaming process taking place as a result of the introduction of the plastic material thus progress as a single step in terms of process technology. The tool used in the method according to the invention is, therefore, a combined forming and injection-molding or foaming tool.

In a preferred embodiment of the method according to the invention, the semifinished part is formed from a glass-fiber reinforced thermoplastic and the step of deep drawing is a thermoforming process. The resulting component is thus completely made of plastic and then distinguishes itself by a low dead weight. Also, by combining the deep-drawn section and the formed section, a high strength can be imparted to the component. In particular, the strength requirements can be optimally adapted to the system requirements by a corresponding configuration of the material combination and the selected materials. The component completely made from plastic also has no tendency to corrode. By using plastic instead of steel, the resulting component also distinguishes itself by reduced investment costs. Metallic insert parts, for example threaded bushings or sheet-metal inserts for screw connections, may be contained in the finished component.

The required strength or stiffness of the component can be adjusted in particular by defining the direction of the fibers in the thermoplastic in relation to the tool.

By encapsulation in the course of introducing the plastic material, that is to say during the step of injection molding, functionalities can be integrated into the component. In this way, screw domes, alternating cable ducts and the like can be integrated. To this end, it is preferable for an insert part to be inserted into the tool and bonded to the component by the introduction of the plastic material, or bonded to the deep-drawn section by means of the plastic material.

By way of example, the method according to the invention can be used for manufacturing a cover element of a roof-opening system. In this case, the insert part is formed, for example, by a glass panel, and the deep-drawn section is an interior metal cover sheet of the cover element, which interior metal cover sheet is bonded to the glass panel via the formed section, which consists, for example, of glass-fiber reinforced polyurethane.

In particular, a sliding-roof frame of a roof-opening system can be manufactured based on the method according to the invention.

In the event that the component is a sliding-roof frame, preferably the deep-drawn section predefines the stiffness of the sliding-roof frame and the formed section represents a functionality of the sliding-roof frame. By way of example, the formed section serves for the connection of the sliding-roof frame to the vehicle body.

Alternatively, it is also conceivable that the component is a mechanical component of the kinematics of a sliding roof or a sliding-roof liner of the roof-opening system.

The invention also relates to a component of a roof-opening system of a motor vehicle. This component is formed by a one-piece structural unit which comprises at least one deep-drawn section of a deep-drawn, panel-shaped material and one formed section formed on the deep-drawn section, said formed section being of injection-molded or foamed plastic.

A one-piece structure in the sense of the invention is present when a form fit and material cohesion exist between the deep-drawn section and the formed section; consequently a material composite is present.

The component is in particular a sliding-roof frame of the roof-opening system, which sliding-roof frame comprises a frame front part, which extends in the transverse direction of the vehicle, and two lateral spars, which extend in the longitudinal direction of the vehicle. The frame front part and the lateral spars are configured as a one-piece structural unit which are formed by the deep-drawn section and the formed section.

The one-piece structural unit, which forms the sliding-roof frame, may also comprise further transverse struts which, for example in a central section and on the rearward ends, form a connection between the lateral spars.

Further advantages and advantageous embodiments of the subject matter of the invention can be obtained from the description, the drawing and the patent claims.

An exemplary embodiment of a sliding-roof frame according to the invention and its manufacture are schematically illustrated in a simplified manner in the drawing and are explained in more detail in the following description.

In the drawing:

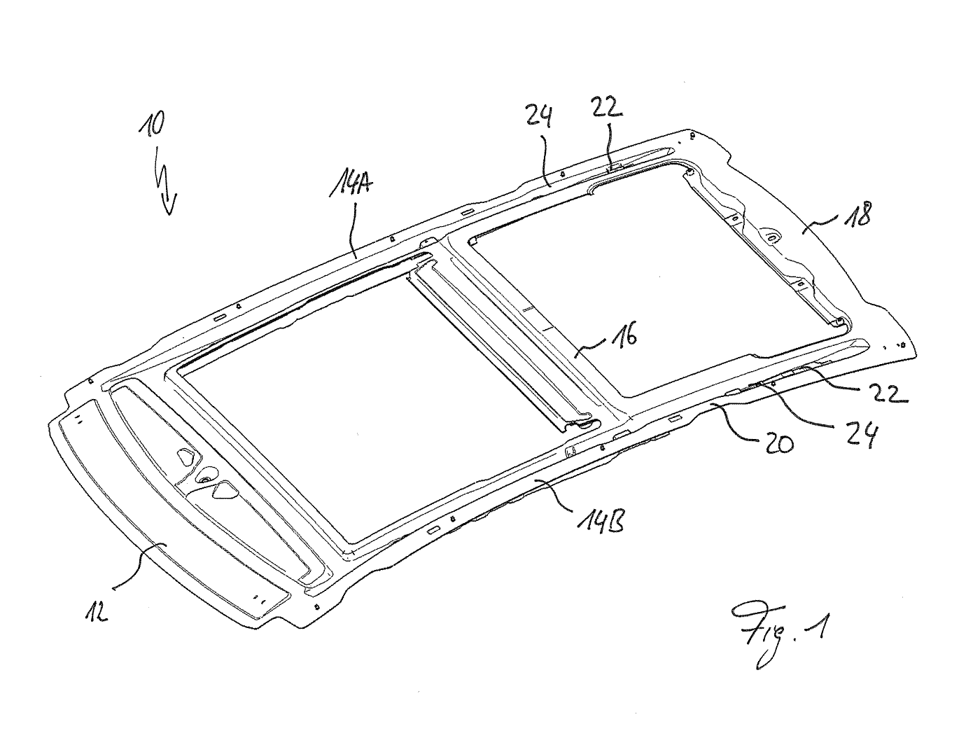

FIG. 1 shows a perspective view of a sliding-roof frame;

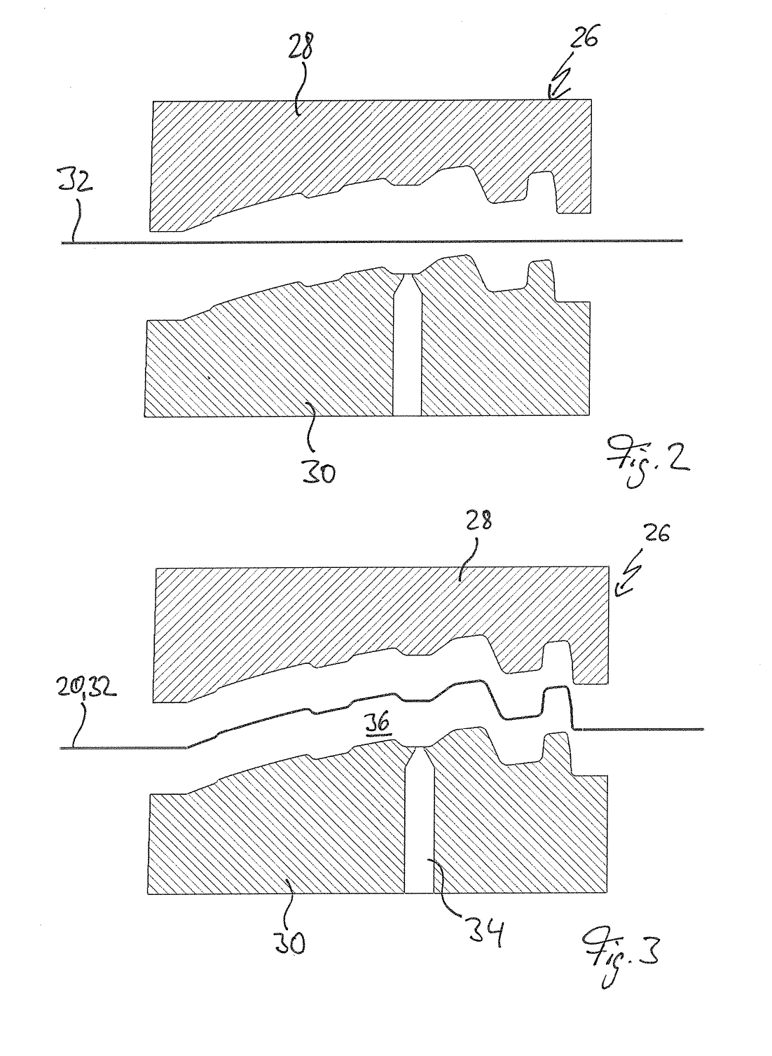

FIG. 2 shows a molding tool in a first process step for manufacturing the sliding-roof frame; and

FIG. 3 shows the molding tool in a second process step.

In FIG. 1 a sliding-roof frame 10, which serves for integrating a roof-opening system into the roof of a motor vehicle otherwise not illustrated in more detail, is illustrated. The sliding-roof frame 10 comprises a frame front part 12 and two lateral spars 14A and 14B, which each extend along a roof edge and which are connected to one another in a central section by a transverse spar 16 and at the rear by a transverse spar 18.

The sliding-roof frame 10 is made of plastic and represents a one-piece structural unit which comprise a deep-drawn section 20 of a glass-fiber reinforced thermoplastic and formed sections 22 formed on the deep-drawn section 20, said formed sections 22 consisting of an injection-molded plastic.

The deep-drawn section 20 extends across the entire area of the sliding-roof frame 10 and is formed by thermoforming a panel-shaped semifinished part composed of the glass-fiber reinforced thermoplastic. The formed sections 22 are locally formed on the deep-drawn section 2 in mountings 24 of the deep-drawn section 20.

The sliding-roof frame 10 is therefore a composite component which is made from two different plastics, one plastic forming the deep-drawn section 20 and the other plastic forming the formed sections 22.

The manufacture of the sliding-roof frame 10 is explained in the following by means of FIGS. 2 and 3.

A semifinished part of a panel-shaped, glass-fiber reinforced thermoplastic 32 is inserted into a tool 26 which comprises an upper die 28 and a lower die 30 and which is configured as a combined thermoforming and injection-molding tool. Prior to being inserted into the tool 26, or inside the tool 26, the thermoplastic 32 is heated and softened such that it can be subjected to a forming process. Subsequently, the upper die 28 is moved towards the lower die 30, such that the thermoplastic 32 is formed according to the geometry of the upper die 28 and the geometry of the lower die 30. Subsequently, the upper die 28 and the lower die 30 are moved apart again. By means of the deep-drawing process described above, the deep-drawn section 20 of the sliding-roof frame 10 is made from the thermo-plastic 32.

Subsequently, without repositioning the thermoplastic 32 or the deep-drawn section 20, a plastic material is injected via a duct 34 of the lower die 30 into a cavity 36 of the tool 26, the geometry of said cavity being defined by the upper die 28, the lower die 30 and by the deep-drawn section 20 which was formed from the thermoplastic 32. On account of this, the formed sections 22 are bonded to the deep-drawn section 20.

Subsequently, the finished composite component consisting of deep-drawn section 20 and formed section 22 can be demolded from the tool 26.

In order be able to impart the required mechanical properties to the sliding-roof frame, the insertion of the thermoplastic 32 into the tool 26 takes place with a predefined orientation of the glass fibers contained in the thermoplastic 32.

The deep-drawn section 20 predefines the basic shape of the sliding-roof frame 10. The formed sections 22 may represent local reinforcements or stiffenings of the deep-drawn section 20 and also function elements of the sliding-roof frame 10, such as, for example, screw domes, wind deflector mountings or the like.

### LIST OF REFERENCE SIGNS

10 Sliding-roof frame
12 Frame front part
14 Lateral spar
16 Transverse spar
18 Transverse spar
20 Deep-drawn section
22 Formed section
24 Mounting
26 Tool
28 Upper die
30 Lower die
32 Thermoplastic
34 Duct
36 Cavity

1.-9. (canceled)

10. A method for manufacturing a sliding-roof frame of a roof-opening system of a motor vehicle in a tool having at least one mold cavity, comprising the steps of:
inserting at least one semi-finished part configured in the shape of a panel into the tool;
deep-drawing the semi-finished part in the tool for configuring at least one deep-drawn section of the sliding-roof frame, wherein the semi-finished part is formed from a glass-fiber reinforced thermoplastic and the step of deep drawing is a thermoforming process;
then, introducing a plastic material into the mold cavity of the tool for forming at least one formed section, which is injection-molded or foamed, and for bonding said formed section to the deep-drawn section; and
demolding the sliding-roof frame from the tool.

11. The method as claimed in claim 10, wherein a fiber direction of the fibers in the thermoplastic is defined in relation to the tool.

12. The method as claimed in claim 10, wherein an insert part is inserted into the tool and is bonded to the deep-drawn section by the introduction of the plastic material.

13. The method as claimed in claim 10, wherein the component is a sliding-roof frame and wherein the formed section comprises a function element of the sliding-roof frame.

14. A sliding-roof frame of a roof-opening system of a motor vehicle, comprising:
the frame formed by a one-piece structural unit which comprises at least one deep-drawn section of a deep-drawn, panel-shaped material being a glass-fiber reinforced thermoplastic, and one formed section formed on the deep-drawn section,
the formed section being of injection-molded or foamed plastic.

15. The sliding-roof frame claimed in claim 14, wherein it comprises a frame front part, which extends in the transverse direction of the vehicle, and two lateral spars, which each extend in the longitudinal direction of the vehicle, wherein the frame front part and the lateral spars form the one-piece structural unit of at least one deep-drawn section (20) and at least one formed section (22).
